(19) United States
(12) Patent Application Publication
(10) Pub. No.: US 2004/0010087 A1
(43) Pub. Date: Jan. 15, 2004

(54) Polypropylene resin composition and heat-shrinkable film obtained from the same

(75) Inventors: Yoichi Obata, Sodegaura-shi (JP); Takeshi Ebara, Chiba-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/429,854

(22) Filed: May 6, 2003

(30) Foreign Application Priority Data
May 9, 2002 (JP) 2002-133801

(51) Int. Cl. C08L 23/00; C08L 23/04

(52) U.S. Cl. 525/240

(57) ABSTRACT

Disclosed is a polypropylene resin composition containing from 20 to 99.99 parts by weight of a propylene-based polymer (A) having a die swell ratio of less than 1.7 and a melting point defined as a peak temperature of a peak with a maximum intensity in a melting curve measured by DSC of from 125 to 139° C., and from 0.01 to 80 parts by weight of a propylene-based polymer (B) having a die swell ratio of not less than 1.8. This resin composition is suitable as a raw material of a heat-shrinkable film superior in rigidity, heat shrinkage and weld-cut sealability. A heat-shrinkable film obtainable from the resin composition is also disclosed.

### BACKGROUND OF THE INVENTION

1. Field of the Invention

The present invention relates to a polypropylene resin composition and a heat-shrinkable film obtainable by using the resin composition. In more detail, the present invention relates to a polypropylene resin composition which is superior in stretch processability and which is suitable as a raw material of a heat-shrinkable film superior in rigidity, heat shrinkage and weld-cut sealability and to a heat-shrinkable film superior in rigidity, heat shrinkage and weld-cut sealability obtainable by using the resin composition.

2. Description of the Related Art

A heat-shrinkable film is, in general, a film that is used in such a manner that a single object to be wrapped or an aggregate comprising a plurality of objects to be wrapped is wrapped roughly with the heat-shrinkable film first and then the film is heated to shrink and that is capable of fixing, holding and wrapping an object to be wrapped when it is used by being heated and made shrink.

Such a heat-shrinkable is generally required to shrink at a temperature lower than the melting point of the film and to exhibit a high shrinkage. Furthermore, in recent years, the wrapping speed of automatic wrapping machines has been increased. Therefore, a heat-shrinkable film has come to be desired not to cause defective sealing, e.g. a pinhole formed in a sealed portion, during weld-cut sealing employed in a wrapping process using an automatic wrapping machine. In addition, a heat-shrinkable film is desired to cause defective sealing, e.g. formation of a pinhole in a seal portion during weld-cut sealing used in a wrapping process using an automatic wrapping machine. It is desired also to have a high rigidity so as not to mackle when multicolor printing is applied to the heat-shrinkable film. In addition, along with increase-of speed of film fabrication, it is desired that stretch processability during film fabrication be good.

As an approach to improve a pinhole resistance after weld-cut sealing, JP-A-10-7816 discloses a method comprising addition of a nucleating agent to a polypropylene resin. JP-A-2000-336221 discloses a polypropylene resin composition that comprises a polypropylene resin which has an MFR of from 0.3 to 2.5 g/10 min and a flexural modulus of from 500 to 1000 MPa and a polypropylene resin which has a melting point ranging from 135 to 150° C. and being higher than that of the former polypropylene by 5° C. or more, an MFR of from 2.5 to 20 g/10 min and a flexural modulus of from 500 to 1000 MPa.

However, a further improvement has been desired in rigidity and weld-cut sealability of heat-shrinkable films. In addition, an improvement has also been desired in stretch processability of a composition as a raw material of heat-shrinkable films.

The object of the present invention is to provide a polypropylene resin composition which is superior in stretch processability and which is suitable as a raw material of a heat-shrinkable film superior in rigidity, heat shrinkage and weld-cut sealability, and to provide such a heat-shrinkable.

### SUMMARY OF THE INVENTION

In a first aspect, the present invention relates to a polypropylene resin composition comprising from 20 to 99.99 parts by weight of a propylene-based polymer (A) having a die swell ratio of less than 1.7 and a melting point defined as a peak temperature of a peak with a maximum intensity in a melting curve measured by DSC of from 125 to 139° C., and from 0.01 to 80 parts by weight of a propylene-based polymer (B) having a die swell ratio of not less than 1.8.

In a second aspect, the present invention relates to a heat-shrinkable film obtained by stretching at least uniaxially the polypropylene resin composition mentioned above.

### DESCRIPTION OF PREFERRED EMBODIMENTS

The propylene-based polymer (A) used in the present invention is a propylene homopolymer or a propylene-based random copolymer. When the propylene-based polymer (A) used in the present invention is a propylene-based random copolymer, it may be a propylene-based random copolymer obtained by copolymerization of propylene with ethylene and/or at least one comonomer selected from α-olefins having from 4 to 20 carbon atoms.

Examples of the α-olefins having from 4 to 20 carbon atoms include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyle-1-pentene, diethyl-1-butene, 1-nonene, 1-decene, 1-undecene, and 1-dodecene. Preferred are 1-butene, 1-pentene, 1-hexene and 1-octene. More preferred are 1-butene and 1-hexene.

Examples of the propylene-based random copolymer used as the propylene-based polymer (A) in the present invention include propylene-ethylene random copolymers, propylene-α-olefin random copolymers and propylene-ethylene-α-olefin random copolymers. Examples of the propylene-α-olefin random copolymers include a propylene-1-butene random copolymer, a propylene-1-hexene random copolymer and a propylene-1-octene random copolymer. Examples of the propylene-ethylene-α-olefin random copolymers include a propylene-ethylene-1-butene random copolymer, a propylene-ethylene-1-hexene random copolymer and a propylene-ethylene-1-octene random copolymer. Preferred are a propylene-ethylene random copolymer, a propylene-1-butene random copolymer, a propylene-1-hexene random copolymer, a propylene-ethylene-1-butene random copolymer and a propylene-ethylene-1-hexene random copolymer.

When the propylene-based random copolymer used as the propylene-based polymer (A) in the present invention is a propylene-ethylene random copolymer, the content of ethylene is usually from 1 to 7% by weight, and in view of stretch processability of a resulting polypropylene resin composition or rigidity of a heat-shrinkable film, it is preferably from 2 to 7% by weight, more preferably from 3 to 6% by weight.

When the propylene-based random copolymer used as the propylene-based polymer (A) in the present invention is a propylene-α-olefin random copolymer, the content of α-olefin is usually from 1 to 30% by weight, and in view of stretch processability of a resulting polypropylene resin composition or rigidity of a heat-shrinkable film, it is preferably from 2 to 10% by weight, more preferably from 3 to 7% by weight.

When the propylene-based random copolymer used as the propylene-based polymer (A) in the present invention is a propylene-ethylene-α-olefin random copolymer, the content of ethylene is usually from 0.1 to 7% by weight, and in view of stretch processability of a resulting polypropylene resin composition or rigidity of a heat-shrinkable film, it is preferably from 2 to 6% by weight, more preferably from 2 to 4% by weight.

When the propylene-based random copolymer used as the propylene-based polymer (A) in the present invention is a propylene-ethylene-α-olefin random copolymer, the content of α-olefin is usually from 1 to 30% by weight, and in view of stretch processability of a resulting polypropylene resin composition or rigidity of a heat-shrinkable film, it is preferably from 2 to 10% by weight, more preferably from 3 to 7% by weight.

The propylene-based polymer (A) used in the present invention has a die swell ratio of less than 1.7, preferably from 1.1 to 1.5, more preferably from 1.2 to 1.3. When the die swell ratio is 1.7 or more, a resulting heat-shrinkable film may have an insufficient transparency.

The content of the propylene-based polymer (A) used in the present invention is from 20 to 99 parts by weight, preferably from 50 to 99.9 parts by weight, and more preferably from 80 to 99.8 parts by weight. When the content of the propylene-based polymer (A) is less than 20 parts by weight, a resulting heat-shrinkable film may have an insufficient weld-cut sealability. When the content of the propylene-based polymer (A) exceeds 99.99 parts by weight, the polypropylene resin composition may have an insufficient stretch processability.

The melt flow rate of the propylene-based polymer (A) used in the present invention is usually from 0.3 to 20 g/10 minutes, and, in view of the extrusion stability or stretch processability of a resulting polypropylene resin composition, is preferably from 0.5 to 10 g/10 minutes, and more preferably from 0.8 to 7 g/10 minutes.

The melting point, which is defined as a peak temperature of a peak with a maximum intensity in a melting curve measured by DSC, of the propylene-based polymer (A) used in the present invention is usually from 125 to 139° C., and, in view of the stretch processability of the resulting polypropylene resin composition and the rigidity of a resulting heat-shrinkable film, is preferably from 128 to 138° C., and more preferably from 129 to 135° C.

When the propylene-based random copolymer used as the propylene-based polymer (A) in the present invention is a propylene-ethylene-α-olefin random copolymer, the amount of a resin which elutes at temperatures not higher than 40° C. in a temperature rising elution fractionation method using orthodichlorobenzene as a solvent is preferably from 2.5 to 7% by weight, more preferably from 2.5 to 6% by weight, and still more preferably from 4 to 6% by weight in view of stretch processability, bleeding property of additives, such as lubricants and antistatic agents, to a surface of a film, and anti-blocking property of a film.

In the temperature raising elution fractionation method, the amount of a resin eluting at temperatures higher than 40° C. but not higher than 100° C. is preferably from 84 to 97.5% by weight, more preferably from 89 to 97.5% by weight, and still more preferably from 94 to 96% by weight in view of heat shrinkage and stretch processability.

Furthermore, in the temperature rising elution fractionation method, the amount of a resin eluting at temperatures higher than 100° C. but not higher than 130° C. is preferably from 0 to 9% by weight, more preferably from 0 to 5% by weight, and still more preferably from 0 to 2% by weight in view of stretch processability.

The propylene-based polymer (B) used in the present invention has a die swell ratio of not less than 1.8, preferably from 1.8 to 3, more preferably from 2 to 3. When the die swell ratio is less than 1.8, a resulting heat-shrinkable film may have an insufficient weld-cut sealability.

The content of the propylene-based polymer (B) used in the present invention is from 0.01 to 80 parts by weight, preferably from 0.1 to 50 parts by weight, and more preferably from 0.2 to 20 parts by weight. When the content of the propylene-based polymer (B) is less than 0.01 parts by weight, a resulting heat-shrinkable film may have an insufficient weld-cut sealability. When the content of the propylene-based polymer (B) exceeds 80 parts by weight, a resulting polypropylene resin composition may have an insufficient stretch processability.

The melt flow rate of the propylene-based polymer (B) used in the present invention is usually from 0.5 to 10 g/10 minutes, and, in view of the transparency of a resulting heat-shrinkable film or the stretch processability of a resulting polypropylene resin composition, is preferably is from 2 to 20 g/10 minutes, and more preferably from 3 to 14 g/10 minutes.

The melting point, which is defined as a peak temperature of a peak with a maximum intensity in a melting curve measured by DSC, of the propylene-based polymer (B) used in the present invention is usually from 135 to 170° C., and, in view of the rigidity of a resulting heat-shrinkable film and the stretch processability of the resulting polypropylene resin composition, is preferably from 145 to 168° C., and more preferably from 160 to 166° C. It usually is difficult to produce a propylene-based polymer having a melting point higher than 170° C.

The amount of a cold xylene-soluble fraction (CXS) of the propylene-based polymer (B) used in the present invention is usually up to 10% by weight, and, in view of the rigidity and anti-blocking property of a resulting heat-shrinkable film and the stretch processability of the resulting polypropylene resin composition, more preferably from 0.1 to 6% by weight, more preferably from 0.4 to 1% by weight.

The flexural modulus of the propylene-based polymer (B) used in the present invention is usually from 500 to 2100 MPa and, in view of the rigidity and anti-blocking property of a resulting heat-shrinkable film and the stretch processability of the resulting polypropylene resin composition, preferably from 700 to 2000 MPa, more preferably from 1200 to 1900 MPa.

As the propylene-based polymer (B) used in the present invention, known propylene-based polymers may be employed, example of which include propylene polymers having a wide molecular weight distribution produced by multi-stage polymerization and non-linear propylene polymers having a strain hardening elongational viscosity.

The propylene-based polymer (B) is preferably a propylene polymer (C) obtained by a polymerization method comprising a step of producing a crystalline propylene polymer portion (a) having an intrinsic viscosity of not less than 5 dl/g and a step of producing a crystalline propylene polymer portion (b) having an intrinsic viscosity of less than 3 dl/g, wherein the content of the crystalline propylene polymer portion (a) relative to the propylene polymer (C) is from 0.05 to 35% by weight, wherein the propylene polymer (C) has an intrinsic viscosity of less than 3 dl/g and a molecular weight distribution of less than 10.

Specific examples of a method for producing the propylene-based polymer (C) include:

batch polymerization in which a crystalline propylene polymer portion (a) is produced in a first stage and subsequently, in a second stage, a crystalline propylene polymer portion (b) is produced in the polymerization vessel the same as that where the crystalline propylene polymer portion (a) was produced; and

continuous polymerization in which two or more polymerization vessels are arranged tandem, the crystalline propylene polymer portion (a) is produced in a first stage, the product obtained in the first stage is transferred to the next polymerization vessel, in which the a propylene polymer portion (b) is produced as a second stage. In the continuous polymerization, each of the first stage and the second stages may use one polymerization vessel or two or more polymerization vessels.

The intrinsic viscosity of the crystalline propylene polymer portion (a) is usually 5 dl/g or more. When being 5 dl/g or more, the effect of improving stretchability of the polypropylene resin composition of the present invention and heat shrinkage of a heat-shrinkable film will be enhanced. The intrinsic viscosity of the polymer portion (a) is preferably from 5 to 15 dl/g, more preferably from 6 to 15 dl/g, still more preferably from 6 to 13 dl/g, and particularly preferably from 7 to 11 dl/g.

The content of the crystalline propylene polymer portion (a) based on the propylene polymer (C) is from 0.05 to 35% by weight. When the content is within this range, it is easy to adjust the die swell ratio of the propylene polymer (C) to a proper range. The content of the polymer portion (a) based on the propylene polymer (C) is preferably from 0.1 to 25% by weight, more preferably from 0.3 to 18% by weight.

The intrinsic viscosity of the crystalline propylene polymer portion (b) is usually less than 3 dl/g. When being less than 3 dl/g, the polypropylene resin composition of the present invention will be superior in flowability and processability. The intrinsic viscosity of the polymer portion (b) is preferably from 0.5 to 3 dl/g, more preferably from 0.5 to 2 dl/g, still more preferably from 0.8 to 2 dl/g, and particularly preferably from 1 to 1.8 dl/g.

The intrinsic viscosity of the crystalline propylene polymer portion (b) can be adjusted to less than 3 dl/g by properly setting the manufacturing conditions of the crystalline propylene polymer portion (b).

The intrinsic viscosity [η]_{b} of the crystalline propylene polymer portion (b) can be determined in the following way. In the case of a propylene polymer (C) made up of a polymer portion (a) and a polymer portion (b), assuming an additive property of intrinsic viscosities to be held, the intrinsic viscosity [η]_{b} of the crystalline propylene polymer portion (b) is determined usually from the following equation (1) using the intrinsic viscosity [η]_{c} of the propylene polymer (C) obtained finally, the intrinsic viscosity [η]ₐ of the polymer portion (a) and the contents (% by weight) of the polymer portions (a) and (b) based on the propylene (C):

[η]_{b}=([η]_{c}×100−[η]ₐ×Wₐ)÷W_{b} (1)

[η]_{c}: Intrinsic viscosity (dl/g) of propylene polymer (C)

[η]ₐ: Intrinsic viscosity (dl/g) of crystalline propylene polymer portion (a)

Wₐ: Content (% by weight) of crystalline propylene polymer portion (a)

W_{b}: Content (% by weight) of crystalline propylene polymer portion (b)

The intrinsic viscosity of the propylene polymer (C) is usually less than 3 dl/g. When being less than 3 dl/g, the polypropylene resin composition of the present invention will be superior in flowability and processability. The intrinsic viscosity of the propylene polymer (C) is preferably not less than 1 dl/g but less than 3 dl/g, more preferably not less than 1.2 dl/g but not more than 2.8 dl/g.

The molecular weight distribution of the propylene polymer (C) is usually less than 10. When the molecular weight distribution is less than 10, a resulting polypropylene resin composition is of good stretching processablity. The molecular weight distribution of the propylene polymer (C) is preferably from 4 to 8.

In view of melt strength of the propylene polymer (C), it is preferable that the intrinsic viscosity [1] a of the polymer portion (a) and the content Wa (% by weight) of the polymer portion (a) based on the propylene polymer (C) satisfy the following equation (2):

Wₐ>400×EXP(−0.6×[η]ₐ) (2)

When the content Wₐ and the intrinsic viscosity [η]ₐ satisfy the relation of equation (2) above, it is easy to adjust the die swell ratio of the propylene polymer (C) to a proper range.

The polymer portion (a) and the polymer portion (b) are individually crystalline propylene polymer portions having an isotactic polypropylene crystal structure and preferably are a homopolymer of propylene or a copolymer of propylene with ethylene and/or a copolymer, e.g. an α-olefin having from 4 to 12 carbon atoms, in an amount such that the copolymer does not lose crystallinity. Examples of α-olefin include 1-butene, 4-methyl-1-pentene, 1-hexene, and 1-octene. The “amount such that a copolymer does not lose crystallinity” varies depending upon the kind of the comonomer. In the case of ethylene, the content of repeating units derived from ethylene in a copolymer is usually up to 10% by weight. In the case of α-olefin such as 1-butene, the content of repeating units derived from the α-olefin is usually up to 30% by weight.

Another preferable example of the polymer portion (b) is a polymer in which in addition to the above-mentioned crystalline propylene polymer portion a non-crystalline ethylene-α-olefin copolymer is also dispersed in the crystalline propylene polymer portion (a).

The polymer portion (a) and the polymer portion (b) are each particularly preferably a homopolymer of propylene, a random copolymer of propylene and ethylene in which the content of repeating units derived from ethylene is up to 10% by weight, a random copolymer of propylene and α-olefin having from 4 to 12 carbon atoms in which the content of repeating units derived from the α-olefin having from 4 to 12 carbon atoms is up to 30% by weight, or a random terpolymer of propylene, ethylene and α-olefin having from 4 to 12 carbon atoms in which the content of repeating units derived from ethylene is up to 10% by weight and the content of repeating units derived from the α-olefin having from 4 to 12 carbon atoms is up to 30% by weight. In these cases, most preferable α-olefin is 1-butene.

The comonomer content of the polymer portion (a) and that of the polymer portion (b) may be the same or different. The polymer portion (a) and the polymer portion (b) may be bonded together in a block-like manner. Moreover, a polymer portion (a) and a polymer portion (b) bonded together in a block-like fashion may be present together with polymer portions (a) and polymer portions (b) in other situations.

The propylene-based polymer (B) is preferably a non-linear polypropylene (D) having a branch index of less than 1 and a degree of strain hardening of 0.1 or more.

In view of weld-cut sealability and transparency of a heat-shrinkable film to be obtained, the branch index of the non-linear polypropylene (D) is preferably less than 1, more preferably from 0.1 to 0.99, and still more preferably from 0.9 to 0.95.

In view of weld-cut sealability and transparency of a heat-shrinkable film to be obtained, the degree of strain hardening of the non-linear polypropylene (D) is preferably more than 0.1, more preferably from 0.1 to 0.95, and still more preferably from 0.4 to 0.9.

A method for producing the non-linear polypropylene (D) may be a known production method, examples of which include a method comprising irradiating a linear propylene polymer with a high-energy ionized radiation, a method comprising melt-kneading a mixture of a linear propylene polymer and a peroxide, and a method comprising copolymerising a multifunctional comonomer having two or more double bonds with propylene.

The melt flow rate of the polypropylene resin composition of the present invention is usually from 0.3 to 20 g/10 minutes, and in view of flowability during extrusion processing and stretch processability, it is preferably from 0.5 to 15 g/10 minutes, more preferably from 1 to 10 g/10 minutes.

The melting point of the polypropylene resin composition of the present invention is usually from 130 to 145° C., and in view of the stretch processability of the polypropylene resin composition and the rigidity of a heat-shrinkable film, it is preferably from 132 to 143° C., more preferably from 133 to 142° C.

The amount of a cold xylene-soluble fraction (CXS) of the polypropylene resin composition of the present invention is usually not more than 6% by weight. In view of simultaneous exhibition of preferable stretch processability of a polypropylene resin composition and rigidity and heat shrinkage of a heat-shrinkable film and also in view of anti-blocking property of a heat-shrinkable film, it is preferably from 0.1 to 5% by weight, more preferably from 0.5 to 3% by weight.

A process for producing the polypropylene resin composition of the present invention may be a process comprising producing the propylene-based polymer (A) and the propylene-based polymer (B) separately and then mixing the propylene-based polymer (A) and the propylene-based polymer (B) produced separately, and a process comprising producing the propylene-based polymer (A) and the propylene-based polymer (B) in different stages by use of multi-stage polymerization containing two or more stages.

In the process comprising producing the propylene-based polymer (A) and the propylene-based polymer (B) separately and then mixing the propylene-based polymer (A) and the propylene-based polymer (B) produced separately, the method for producing the propylene-based polymer (A) and the propylene-based polymer (B) separately may be a known polymerization method, examples of which include solvent polymerization, which is carried out in the presence of an inert solvent, bulk polymerization, which is carried out in the presence of a liquid monomer, and gas phase polymerization, which is carried out in substantial absence of a liquid medium. Preferred is the gas phase polymerization. Moreover, polymerization methods comprising a combination of two or more polymerization methods mentioned above and multi-stage polymerization having two or more stages may also be applied.

The method for mixing the propylene-based polymer (A) and the propylene-based polymer (B) produced separately may be any method as long as it is possible to disperse polymer (A) and polymer (B) uniformly. Examples thereof include:

(1) a method comprising mixing polymer (A) and polymer (B) with a ribbon blender, a Henschel mixer, a tumble mixer or the like, and melt kneading the mixture using an extruder or the like;

(2) a method comprising melt kneading and pelletizing separately polymer (A) and polymer (B), mixing the pelletized polymer (A) and pelletized polymer (B) by a method the same as that described above, and then further melt kneading;

(3) a method comprising melt kneading and pelletizing separately polymer (A) and polymer (B), blending the pelletized polymer. (A) and pelletized polymer (B) by dry blending or the like, and then mixing directly with a film processing machine; and

(4) a method comprising melt kneading and pelletizing separately polymer (A) and polymer (B), feeding the pelletized polymer (A) and the pelletized polymer (B) separately and mixing them.

Furthermore, a method comprising preparing in advance a master batch which comprises 100 parts by weight of the propylene-based polymer (B) and from 1 to 99 parts by weight of the propylene-based polymer (A), and mixing the master batch properly with other portions of propylene-based polymer (A) and propylene-based polymer (B) so that the concentration of the propylene-based polymer (A) becomes a predetermined concentration.

In addition, when the propylene-based polymer (A) and the propylene-based polymer (B) produced separately are mixed, stabilizers, lubricants, antistatic agents, anti-blocking agents, various kinds of inorganic or organic fillers, and the like may be added.

In the method of producing the propylene-based polymer (A) and the propylene-based polymer (B) separately in dif ferent stages using multi-stage polymerization having two or more stages, the method for polymerizing the propylene-based polymer (A) and the propylene-based polymer (B) may be known polymerization methods, examples of which include a method comprising an optional combination of two or more stages using, for example, solvent polymerization, which is carried out in the presence of an inert solvent, bulk polymerization, which is carried out in the presence of a liquid monomer, gas phase polymerization, which is carried out in substantial absence of a liquid medium wherein the propylene-based polymer (A) and the propylene-based polymer (B) are respectively polymerized in different stages.

A polypropylene resin composition obtained by a method of polymerizing the propylene-based polymer (A) and the propylene-based polymer (B) separately in different stages using multi-stage polymerization having two or more stages may be further blended. The method for further blending may be a method of melt kneading with an extruder or the like.

As a catalyst used for the polymerization of the propylene-based polymer (A) and the propylene-based polymer (B), a catalyst for stereoregulating polymerization of propylene is used both in the case of polymerizing these polymers separately and in the case of using multi-stage polymerization.

Examples of the catalyst for stereoregulating polymerization of propylene include catalyst systems obtained by combining a solid catalyst component such as a titanium trichloride catalyst, a catalyst essentially comprising titanium, magnesium, halogen and an electron donor with an organoaluminum compound and, if needed, a third component such as a electron donating compound; metallocene catalysts; and the like.

Preferred are catalyst systems obtained by combining a solid catalyst component essentially comprising magnesium, titanium, halogen and an electron donor, an organoaluminum compound and an electron donating compound, specific examples of which include catalyst systems disclosed in JP-A-61-218606, 61-287904 and 7-216017.

Regarding the heat shrinkage of the heat-shrinkable film of the present invention, the value of heat shrinkage obtained in a measurement in which a heat-shrinkable film is immersed in a silicone oil at 110° C. for five seconds, with respect to at least uniaxial direction, is preferably not less than 5%, more preferably not less than 12%, and particularly preferably not less than 15%.

To the polypropylene resin composition of the present invention, an antioxidant may be incorporated, as needed. The type of the antioxidant may be that already known, examples of which include phosphorus-based antioxidants, phenol-based antioxidants and sulfur-based antioxidants. These antioxidants may be used alone or in combination of at least two of them.

Examples of phosphorus-based antioxidants include tris(2,4-di-tert-butylphenyl)-phosphite (Irgaphos 168 manufactured by Ciba Specialty Chemicals), tetrakis(2,4-di-tert-butylphenyl)4,4-biphenylene-di-phosphi te (Sandostab P-EPQ manufactured by Sandoz), and bis(2,4-di-tert-butyl-6-methylphenyl)ethyl phosphite (Irgaphos 38 manufactured by Ciba Specialty Chemicals).

Preferred are tris(2,4-di-tert-butylphenyl)-phosphite (Irgaphos 168 manufactured by Ciba Specialty Chemicals) and tetrakis(2,4-di-tert-butylphenyl)4,4-biphenylene-di-phosphite (Sandostab P-EPQ manufactured by Sandoz). More preferred is tris(2,4-di-tert-butylphenyl)-phosphite (Irgaphos 168 manufactured by Ciba Specialty Chemicals).

Examples of phenol-based antioxidants include pentaerythrityl-tetrakis[3-(3,5-di-tert-butyl-4-hydroxyphen yl)-propionate] (Irganox 1010 manufactured by Ciba Specialty Chemicals.), n-octadecyl-(-(3,5-di-tert-butyl-4-hydroxyphenyl)-propionat e (Irganox 1076 manufactured by Ciba Specialty Chemicals), tris(3,5-di-tert-butyl-4-hydroxybenzyl) isocyanurate (Irganox 3114 manufactured by Ciba Specialty Chemicals), tocopherol (vitamin E), 3,9-bis[2-{3-(3-tert-butyl-4-hydroxy-5-methylphenyl)propion yloxy}-1,1-dimethylethyl]-2,4,8,10-tetraoxaspiro[5,5]undeca ne (Sumilizer GA80 manufactured by Sumitomo Chemical Co., Ltd.), and 2,6-di-tert-butyl-4-methylphenol (BHT manufactured by Sumitomo Chemical Co., Ltd.)

Preferred are pentaerythritol-tetrakis[3-(3,5-di-tert-butyl-4-hydroxyphen yl)propionate] (Irganox 1010 (manufactured by Ciba Specialty Chemicals)), 3,9-bi[2-{3-(3-tert-butyl-4-hydroxy-5-methylphenyl)propiony loxy}-1,1-dimethylethyl]-2,4,8,10-tetraoxaspiro[5,5]undecan e (Sumilizer GA80 (manufactured by Sumitomo Chemical Co., Ltd.)) and 6-di-tert-butyl-4-methylphenol (BHT (manufactured by Sumitomo Chemical Co., Ltd.)). More preferred are pentaerythritol-tetrakis[3-(3,5-di-tert-butyl-4-hydroxyphen yl)propionate] (Irganox 1010 (manufactured by Ciba Specialty Chemicals)), 3,9-bi[2-{3-(3-tert-butyl-4-hydroxy-5-methylphenyl)propiony loxy}-1,1-dimethylethyl]-2,4,8,10-tetraoxaspiro[5,5]undecan e (Sumilizer GA80(manufactured by Sumitomo Chemical Co., Ltd.)).

Examples of the sulfur-containing antioxidant include pentaerythyl tetrakis(3-laurylthiopropionate), dilauryl 3, 3′-thiodipropionate, dimyristyl 3,3′-thiodipropionate, and distearyl 3,3′-thiodipropionate.

Preferred are pentaerythyl tetrakis(3-laurylthiopropionate) and distearyl 3,3′-thiodipropionate. More preferred is distearyl 3,3′-thiodipropionate.

To the polypropylene resin composition for a heat-shrinkable film of the present invention, an anti-blocking agent may be incorporated, as needed. The anti-blocking agent is a substance capable of preventing a film or films from becoming to be unable to peel during its or their preservation or use due to self-sticking, adhesion or welding.

The anti-blocking agent used in the present invention may be an inαorganic anti-blocking agent and an organic anti-blocking agent. Examples of the inorganic anti-blocking agent include natural silica, synthetic silica, talc, zeolite, kaolin, synthetic aluminasilicate, hydrotalcite-type compounds, calcium carbonate and magnesium oxide. Preferred are synthetic silica and synthetic aluminasilicate.

Examples of the organic anti-blocking agent include melanin-type compounds, fatty acid amide, polymer beads and silicone resin-based organic compounds. Preferred are polymer beads and silicone resin-based organic compounds.

The form of the anti-blocking agent used in the present invention is preferably an amorphous form whose anchor effect makes voids difficult to form. When an unprocessed stretched film is folded with nip rolls during the shaping of the unprocessed stretched film, an anti-blocking agent serves as a nucleus to form voids and, as a result, white streaks may be formed (a phenomenon of blushing at folding may occur) in the film after stretching. Therefore, in view of blushing at folding, the above-mentioned amorphous form is preferred.

The bulk density of the anti-blocking agent used in the present invention is preferably from 0.01 to 0.55 g/cm³, more preferably from 0.10 to 0.31 g/cm³, and still more preferably from 0.12 to 0.28 g/cm³ in view of blushing at folding.

The average particle diameter of the anti-blocking agent used in the present invention is preferably from 0.7 to 5.0 μm, more preferably from 0.8 to 3.0 μm, and still more preferably from 1.5 to 2.9 μm in view of blushing at folding.

The amount of the anti-blocking agent used in the present invention is preferably from 0.01 to 1.0 part by weight, and more preferably from 0.05 to 0.40 parts by weight based on 100 parts by weight of the propylene-ethylene-α-olefin random copolymer. The anti-blocking agent may be used alone or in combination of at least two kinds.

To the polypropylene resin composition for a heat-shrinkable film of the present invention, a neutralizing agent may be incorporated, as needed. The neutralizing agent is a substance capable of acting on an acid substance remaining in a polymer to deactivate it.

Examples of the neutralizing agent used in the present invention include hydrotalcites, metal salts of higher fatty acids, silicates, metal oxides and metal hydroxides.

Examples of the hydrotalcites include hydrous basic carbonates or crystal-water-containing basic carbonates of magnesium, calcium, zinc, aluminum and bismuth. Further, these carbonates may be naturally occurring products or synthetic products. In view of blushing at folding, preferred are DHT-4A and DHT-4C (both available from Kyowa Chemical Industry Co., Ltd.)

Examples of the metal salts of higher fatty acids include magnesium stearate, magnesium laurate, magnesium palmitate, calcium stearate, calcium oleate, calcium laurate, barium stearate, barium oleate, barium laurate, barium arachidate, barium behenate, zinc stearate, zinc oleate, zinc laurate, lithium stearate, sodium stearate, sodium palmitate, sodium laurate, potassium stearate, potassium laurate, calcium 12-hydroxystearate, and calcium montanate. Preferred are calcium stearate and magnesium stearate.

The amount of the neutralizing agent used in the present invention is preferably from 0.005 to 1.0 part by weight, and more preferably from 0.005 to 0.20 parts by weight based on 100 parts by weight of the propylene-ethylene-α-olefin random copolymer. The neutralizing agent may be used alone or in combination of at least two kinds.

To the polypropylene resin composition of the present invention, additives, e.g. ultraviolet absorbers, lubricants, pigments, antistatic agents, copper inhibitors, flame retarders, foaming agents, plasticizers, cell inhibitors, crosslinking agents, flowability improvement agent and light stabilizers, may optionally be incorporated.

The method for mixing the polypropylene resin composition of the present invention, an antioxidant and other additives may, for example, be methods using a Henschel mixer, a tumble mixer or the like. Mixing of the ingredients may be carried out simultaneously or separately.

For the preparation of the polypropylene resin composition of the present invention containing an antioxidant or the like, a single screw extruder, a multi-screw extruder, e.g. a twin screw extruder, or a kneading machine, e.g. a Banbury mixer, a hot roll and a kneader may be used.

A method for forming the heat-shrinkable film of the present invention may be known forming methods, e.g. a method in which a web for stretching is formed using a melt extrusion forming machine and the web is then stretched.

A method for forming the web for stretching may be T-die casting, water-cooling inflation, and the like.

A method for stretching a web for stretching may be uniaxial stretching, such as roll stretching, rolling and tenter transversally uniaxial stretching, biaxial stretching, such as tenter biaxial stretching and tubular biaxial stretching, and the like.

With regard to processing conditions employed during stretch processing, the stretching temperature is preferably from ambient temperature to a melting point of the copolymer used, and the stretch ratio is preferably from 2 to 10 times in both longitudinal and transverse directions. The stretch ratio in the longitudinal direction and that in the transverse direction may be the same or different and may be chosen optionally depending upon applications. In addition, heat setting may be performed after the stretching.

### EXAMPLES

The present invention will be described below concretely with reference to examples and comparative examples. However, the invention is not limited to these examples.

Measurements of physical properties were carried out according to the methods described below.

(1) Intrinsic Viscosity of Polymer (unit: dl/g)

Measurement was conducted in 135° C. tetralin using an Ubbelohde's viscometer. The intrinsic viscosity of a crystalline propylene polymer portion (b) in Referential Example 1 was calculated from equation (1) mentioned previously using the intrinsic viscosities of a crystalline propylene polymer portion (a) and the entire polymer.

(2) Melt Flow Rate (MFR; Unit: g/10 min)

Melt flow rate was measured according to a method of Condition No. 14 provided in JIS K 7210.

(3) Die Swell Ratio (SR)

A diameter of a cross section of an extrudate formed in the measurement of melt flow rate (MFR) according to a method of Condition No. 14 provided in JIS K 7210 was measured and a die swell ratio was determined from equation (3) below.

Die swell ratio=(Diameter of cross section of extrudate)/(diameter of orifice) (3)

The cross section of an extrudate denotes a cross section of an extrudate perpendicular to its extrusion direction. When a cross section is not a true circle, an average of a maximum value and a minimum value of the cross section was considered as a diameter of a cross section of the extrudate.

(4) Branch Index

An intrinsic viscosity was measured according to (1) above and a branch index was determined from the following equation (4):

Branch Index=[Viscosity]ar/[Viscosity]Lin (4)

wherein [Viscosity] ar is an intrinsic viscosity of a branching polypropylene and [Viscosity]Lin is an intrinsic viscosity of a semicrystalline linear polypropylene which has a weight average molecular weight substantially equal to that of the branching polypropylene polymer and which mainly is isotactic.

(5) Degree of Strain Hardening

A degree of strain hardening was determined with a uniaxial elongational viscosity analyzer mfd. by Rheometric Scientific, Inc. under conditions of 230° C. and an elongation rate of 1 (sect1) (a strain rate of 0.33 sec⁻¹ in a linear region)

(6) Molecular Weight Distribution

Measurement was conducted by GPC (gel permeation chromatography) under the conditions shown below. A molecular weight distribution denotes a ratio of a weight average molecular weight (Mw) to a number average molecular weight (Mn), Mw/Mn.

Apparatus: Model 150CV mfd. by Millipore-Waters

Column: Shodex M/S 80

Measuring temperature: 145° C.

Solvent: Orthodichlorobenzene

Sample concentration: 5 mg/8 mL

A calibration curve was made using a standard polystyrene.

(7) Melting Point (Tm; unit: ° C.)

A differential scanning calorimeter (DSC-7 available from Perkin Elmer, Inc.) was used. A propylene polymer composition was hot pressed to form a 0.5 mm thick sheet. That is, the material was preliminarily heated at 230° C. for 5 minutes. Thereafter, the pressure was increased up to a pressure of 50 kgf/cm² over 3 minutes and held for 2 minutes. Then the material was cooled at 30° C. under a pressure of 30 kgf/cm² for 5 minutes. A 10 g of the sheet was heat treated in a nitrogen atmosphere at 220° C. for 5 minutes, followed by cooling to 150° C. at a rate of 300° C./min, followed by holding at 150° C. for 1 minute, followed by cooling to 50° C. at a rate of 5° C./min, followed by holding at 50° C. for 1 minute. Then, the material was-heated from 50° C. up to 180° C. at a rate of 5° C./min and a melting peak temperature obtained during this process was determined as a melting point Tm (° C.)

(8) Ethylene Content and 1-Butene Content (Unit: wt %)

The ethylene content and the 1-butene content (wt %) were determined by a calibration curve method using the absorbances of the characteristic absorptions assigned to a methyl group (—CH₃), a methylene group (—CH₂—) and an ethyl group (—C₂H₅) of an infrared spectrum obtained by measuring the infrared spectrum of the press sheet described in (7) above.

(9) Amount of Xylene-Soluble Fraction (CXS; Unit: wt %)

A 10 g of propylene-based polymer was dissolved in a 1000 ml of boiling xylene and then cooled slowly to 50° C. Subsequently, while stirring in an ice water, the mixture was cooled to 20° C. and left stand at 20° C. overnight. A precipitating polymer was removed by filtration. Xylene was evaporated from the filtrate and the residue was dried at 60° C. under reduced pressure to recover a polymer soluble in 20° C. xylene. Thus, the amount of xylene-soluble fraction was calculated.

(10) Measurement of Amount of Eluted Resin by Temperature-Raising Elution Fractionation Method

Measurement was carried out using an apparatus shown below under conditions shown below.

Machine: CFC Model 150A mfd. by Mitsubishi Chemical Corp.

Detector: Magna-IR550 mfd. by Nicolet-Japan Corp.

Wavelength: data range 2982-2842 cm⁻¹

Column: UT-806M mfd. by Showa Denko K.K. Two columns

Solvent: o-Dichlorobenzene

Flow Rate: 60 ml/hour

Sample Concentration: 100 mg/25 ml

Amount of Sample Injected: 0.8 ml

Carry Conditions: After reducing the temperature at a rate of 1° C./min from 140° C. to 0° C., the sample was left stand for 30 minutes. Thereafter, elution was started with a 0° C. fraction.

(11) Flexural Modulus (Unit: MPa)

Flexural modulus was measured by use of a 1 mm thick pressed sheet obtained by molding according to JIS K 6758 and then conditioning for 72 hours in a constant-temperature constant-humidity room at room temperature (23° C.) at a humidity of 50%.

(12) Film Fabrication (Tenter-Type Sequential Biaxial Stretching Machine)

A resin composition obtained was extruded with a single screw extruder at a resin temperature of 230° C. and cooled with a cooling roll at 25° C., resulting in a sheet 350 μm in thickness. The sheet was then stretched with a tenter-type sequential biaxial stretching machine under stretch condition 1 shown below, resulting in a biaxially stretched film 15 μm in thickness.

Stretch Machine: Tenter-type Sequential Biaxial Stretching Machine mfd. by Mitsubishi Heavy Industries, Ltd.

Stretch Condition 1

Longitudinal Stretch Temperature: 120° C.

Longitudinal Stretch Ratio: 4 times

Transverse Preliminary Heating Temperature: 130° C.

Transverse Stretch Temperature: 125° C.

Transverse Stretch Ratio: 4 times

Rate of Film Take-up: 14.5 m/min

(13) Young's Modulus (Unit: kg/cm²)

A specimen 20 mm in width was cut out from the film obtained under stretch condition 1. An S-S curve thereof was measured at an inter-clip distance of 60 mm and a tensile rate of 5 mm/min using a tensile tester to obtain an initial elastic modulus.

(14) Heat Shrinkage (Unit: %)

A square film specimen whose sides had a length of 90 mm was cut out from the film obtained under stretch condition 1. The specimen was immersed in silicone oil at 110° C. for 5 seconds and then removed therefrom. After cooling at room temperature for 30 minutes, the length of the specimen was measured. The heat shrinkage was calculated using the following equation:

Heat shrinkage=100×[{90−(length after heating)}/90] (5)

(15) Weld-Cut Seal Strength (Unit: N)

A specimen 25 mm in width was cut out from the film obtained under stretch condition 1 along the longitudinal direction (MD) After weld cutting of the specimen at 230° C. using an automatic hot tack tester equipped with a weld-cut seal bar available from Theller, a tensile stress-strain curve was measured at a tensile rate of 5 mm/min with an automatic tensile tester to obtain a rupture strength.

(16) Stretch Processability

The appearance of a film resulting from stretching under stretch condition 1 was evaluated visually. When a film with a good appearance with no uneven stretch was obtained, it was judged that the stretch processability was good. When a film was torn during stretching or a film was unevenly stretched and as a result a film with a poor appearance was obtained, it was judged that the stretch processability was poor.

(Preparation of Propylene-Based Polymer A1)

A copolymer powder of a propylene-based polymer A1 was obtained by copolymerizing propylene, ethylene and 1-butene by gas phase polymerization (catalyst conditions: Al/Ti molar ratio=600, cyclohexylethyldimethoxysilane (Z)/Ti molar ratio=40; polymerization conditions: polymerization temperature=81° C., polymerization pressure=2.1 MPa) in the presence of a catalyst system described in JP-A-7-216017.

(Pelletization of Propylene-Based Polymer A1)

Pellets A1 of propylene-based polymer A1 were prepared by adding 0.01 parts by weight of hydrotalcite as a neutralizing agent, 0.05 parts by weight of Irganox 1010 (supplied by Ciba Specialty Chemicals) and 0.15 parts by weight of Irgaphos 168 (supplied by Ciba Specialty Chemicals), both as antioxidants, 0.1 parts by weight of amorphous silica having a particle size of 2.3 μm as an antiblocking agent and 0.05 parts by weight of erucic amide to 100 parts by weight of powder of propylene-based polymer A1 and then melt kneading at 230° C. The resulting pellets A1 were pellets such that the melt flow rate is 5.8 g/10 min, the die swell ratio is 1.26, the ethylene content is 2.5% by weight, the 1-butene content is 5.3% by weight, the melting point (Tm) is 136.0° C. In temperature raising elution fractionation using orthodichlorobenzene as a solvent, the amount of resin eluted at temperatures not higher than 40° C. was 4.5% by weight. The amount of resin eluted at temperatures higher than 40° C. but not higher than 100° C. was 95.5% by weight. The amount of resin eluted at temperatures higher than 100° C. but not higher than 130° C. is 0% by weight.

(Preparation of Propylene-Based Polymer A2)

A powder of propylene-based polymer A2 was obtained by copolymerizing propylene, ethylene and 1-butene by gas phase polymerization (catalyst conditions: Al/Ti molar ratio=600, cyclohexylethyldimethoxysilane(Z)/Ti molar ratio=0; polymerization conditions: polymerization temperature 81° C., polymerization pressure=2.1 MPa, feeding rate based on 1 ton of a combined feeding rate of propylene, ethylene and 1-butene=25 kg for ethylene and 65 kg for 1-butene) using a catalyst system described in JP-A-7-216017 so that the hydrogen concentration, ethylene concentration and 1-butene concentration became 2.7 vol %, 1.75 vol % and 6.8 vol %, respectively. In temperature raising elution fractionation using orthodichlorobenzene as a solvent of the powder of propylene-based polymer A2, the amount of resin eluted at temperatures not higher than 40° C. in was 4.6% by weight. The amount of resin eluted at temperatures higher than 40° C. but not higher than 100° C. was 95.6% by weight. The amount of resin eluted at temperatures higher than 100° C. but not higher than 130° C. was 0% by weight.

(Pelletization of Propylene-Based Polymer A2)

Pellets A2 of propylene-based polymer A2 were prepared by adding 0.01 parts by weight of hydrotalcite as a neutralizing agent, 0.05 parts by weight of Irganox 1010 (supplied by Ciba Specialty Chemicals) and 0.15 parts by weight of Irgaphos 168 (supplied by Ciba Specialty Chemicals), both as antioxidants, 0.1 parts by weight of amorphous silica having a particle size of 2.3 μm as an antiblocking agent and 0.05 parts by weight of erucic amide to 100 parts by weight of powder of propylene-based polymer A2 and then melt kneading at 230° C. The pellets A2 had a melt flow rate of 3.1 g/10 min, a die swell ratio of 1.19, an ethylene content of 2.5% by weight, a 1-butene content of 6.7% by weight, a melting point (Tm) of 130.7° C., and a coldxylene soluble fraction content (CXS) of 3.1% by weight.

(Preparation of Propylene-Based Polymer A3)

A powder of propylene-based polymer A3 was obtained in the same manner as the production of polymer A2 described above except that the feeding rates of ethylene and 1-butene were changed to 20 kg and 46 kg, respectively, and that the ethylene concentration and the 1-butene concentration were changed to 1.34 vol % and 4.4 vol %, respectively. In temperature raising elution fractionation using orthodichlorobenzene as a solvent of the powder of propylene-based polymer A3, the amount of resin eluted at temperatures not higher than 40° C. in was 3.9% by weight. The amount of resin eluted at temperatures higher than 40° C. but not higher than 100° C. was 96.1% by weight. The amount of resin eluted at temperatures higher than 100° C. but not higher than 130° C. was 0% by weight.

(Pelletization of Propylene-Based Polymer A3)

Pellets A3 of propylene-based polymer A3 were prepared in the same manner as the pelletization of propylene-based polymer A2 described above. The pellets A3 had a melt flow rate of 7.4 g/10 min, a die swell ratio of 1.15, an ethylene content of 2.1% by weight, a 1-butene content of 4.8% by weight, a melting point (Tm) of 141.0° C., and a cold xylene soluble fraction content (CXS) of 1.7% by weight.

(Production of Propylene-Based Polymer A4)

A powder of propylene-based polymer A4 was obtained in the same manner as the production of polymer A2 described previously except that the feeding rates of ethylene and 1-butene were changed to 9.5 kg and 32 kg, respectively, and that the ethylene concentration, the 1-butene concentration and the hydrogen concentration were changed to 0.64 vol %, 3.50 vol % and 2.4 vol %, respectively.

(Pelletization of Propylene-Based Polymer A4)

Pellets A4 of propylene-based polymer A4 were prepared in the same manner as the pelletization of propylene-based polymer A2 described previously. The pellets A4 had a melt flow rate of 9.0 g/10 min, a die swell ratio of 1.16, an ethylene content of 1.1% by weight, a 1-butene content of 4.0% by weight, a melting point (Tm) of 147.0° C., and a cold xylene soluble fraction content (CXS) of 1.3% by weight.

(Process for Production of Propylene-Based Polymer B1)

[1] (Preparation of Solid Catalyst Component)

After a 200-L SUS reactor equipped with a stirrer was purged with nitrogen, 80 L of hexane, 6.55 mol of tetrabutoxytitanium, 2.8 mol of diisobutyl phthalate and 98.9 mol of tetraethoxysilane were fed into the reactor to obtain a homogeneous solution. Then, 51 L of a 2.1 mol/L solution of butylmagnesium chloride in diisobutyl ether was dropped slowly over 5 hours while maintaining the temperature within the reactor at 5° C. After the completion of the dropping, the mixture was stirred further for 1 hour at room temperature and was subjected to solid-liquid separation at room temperature, followed by a three-time repetition of washing the resulting solid with 70 L of toluene.

Next, after such an addition of toluene that the slurry concentration become 0.6 kg/L, a mixed solution of 8.9 mol of n-butyl ether and 274 mol of titanium tetrachloride was added and then 20.8 mol of phthaloyl chloride was added, followed by stirring at 110° C. for 3 hours. Thereafter solid-liquid separation was conducted, followed by a two-time repetition of washing the resulting solid with 90 L toluene at 95° C.

Subsequently, following adjustment of the slurry concentration to 0.6 kg/L, 3.13 mol of diisobutyl phthalate, 8.9 mol of n-butyl ether and 137 mol of titanium tetrachloride were added, followed by stirring at 105° C. for 1 hour. Thereafter solid-liquid separation was conducted at that temperature, followed by a two-time repetition of washing the resulting solid with 90 L toluene at 95° C.

Subsequently, following adjustment of the slurry concentration to 0.6 kg/L, 8.9 mol of n-butyl ether and 137 mol of titanium tetrachloride were added, followed by stirring at 95° C. for 1 hour. Thereafter solid-liquid separation was conducted at that temperature, followed by a three-time repetition of washing the resulting solid with 90 L toluene at the same temperature.

Subsequently, following adjustment of the slurry concentration to 0.6 Kg/L, 8.9 mol of n-butyl ether and 137 mol of titanium tetrachloride were added, followed by stirring at 95° C. for 1 hour. Thereafter a solid-liquid separation was performed at the same temperature, followed by a three-time washing the resulting solid with 90 L of toluene and a subsequent three-time washing with 90 L of hexane. After drying under reduced pressure, 11.0 Kg of a solid catalyst component was obtained.

The solid catalyst component contained 1.9% by weight of titanium atom, 20% by weight of magnesium atom, 8.6% by weight of phthalate, 0.05% by weight of ethoxy group, and 0.21% by weight of butoxy group. Further, the solid catalyst component showed favorable particle properties free from fine powder.

[2] (Preliminary Activation of Solid Catalyst Component)

To a SUS autoclave with a capacity of 3 L equipped with a stirrer, 1.5 L of n-hexane which had been fully dewatered and degassed, 37.5 mmol of triethylaluminum, 3.75 mmol of tert-butyl-n-propyldimethoxysilane and 15 g of the solid catalyst component obtained in [1] above were added. Preliminary activation was conducted by continuously feeding 15 g of propylene over 30 minutes while keeping the temperature in the reactor at 5-15° C.

[3] (Polymerization of Crystalline Propylene Polymer Portion (a))

In a SUS polymerization vessel with a capacity of 300 L, while feeding liquid propylene at a rate of 57 kg/h so as to maintain a polymerization temperature of 60° C. and a polymerization pressure of 27 kg/cm2G, 1.3 mmol/h of triethylaluminum, 0.13 mmol/h of t-butyl-n-propyldimethoxysilane and 0.51 g/h of the solid catalyst component preliminarily activated in the same manner as [2] above were fed continuously to perform propylene polymerization in the substantial absence of hydrogen, obtaining 2.0 kg/h of polymer. The amount of the polymer formed per gram of the catalyst was 3920 g. Apart of the polymer formed was sampled and analyzed. It was found that the polymer had an intrinsic viscosity of 7.7 dl/g. The resulting polymer was transferred continuously to a second polymerization vessel without performing deactivation.

[4] (Polymerization of Crystalline Propylene Polymer Portion (b))

In a fluidized bed reactor (second polymerization vessel) with a capacity of 1 m³ equipped with a stirrer, 18.2 kg/h of propylene homopolymer powder of propylene-based polymer B1 was obtained through continuous propylene polymerization performed by feeding the catalyst-containing polymer transferred from the first polymerization vessel, 60 mmol/h of triethylaluminum and 6 mmol/h of t-butyl-n-propyldimethoxysilane while feeding propylene and hydrogen so as to maintain a polymerization temperature of 80° C., a polymerization pressure of 18 kg/cm²G and a hydrogen concentration in the gas phase of 8 vol %. The resulting polymer had an intrinsic viscosity of 1.9 dl/g.

Based on the above results, the amount of the polymer formed during the polymerization (b) above per gram of the solid catalyst component was calculated to be 31760 g. In addition, the polymerization weight ratio of the first polymerization vessel to the second polymerization vessel and the intrinsic viscosity of (b) were calculated to be 11/89 and 1.9 dl/g, respectively.

[5] (Pelletization of Propylene Homopolymer Powder of Propylene-Based Polymer B1)

By adding 0.1 part by weight of calcium stearate, 0.05 part by weight of Irganox 1010 (commercial name, mfd. by Ciba Specialty Chemicals) and 0.2 part by weight of Sumilizer BHT (commercial name, mfd. by Sumitomo Chemical Co., Ltd.) to 100 parts by weight of a powder of propylene homopolymer of propylene-based polymer B1, and then melt kneading at 230° C., pellets B1 of propylene homopolymer B1 were obtained, the pellets having an intrinsic viscosity of 1.74 dl/g, a weight average molecular weight (Mw) of 3.4×10⁵, a molecular weight distribution (Mw/Mn) of 8.0, an MFR of 12 g/10 min, a die swell ratio (SR) of 2.35, a Tm of 165.2° C., a cold xylene soluble fraction content, CXS, of 0.4% and a flexural modulus of 1810 MPa.

(Propylene-Based Polymer B2)

Cross-linked polypropylene PF814 mfd. by Basell was used. This has a branch index of 0.93, a degree of strain hardening of 0.9, an MFR of 3.3 g/10 min, a die swell ratio (SR) of 2.40, a Tm of 163.8° C., a cold xylene soluble fraction content, CXS, of 2.8% and a flexural modulus of 1370 MPa.

(Production of Propylene-Based Polymer B3)

A propylene-based polymer B3 (propylene homopolymer) was obtained by homopolymerizing propylene by gas phase polymerization (catalyst conditions: Al/Ti molar ratio=450, cyclohexylethyldimethoxysilane(Z)/Ti molar ratio=8; polymerization conditions: polymerization temperature=83° C., polymerization pressure=2.1 MPa) using a catalyst system described in JP-A-7-216017 so that the hydrogen concentration became 0.83 vol %.

(Pelletization of Propylene-Based Polymer B3)

Pellets B3 of propylene-based polymer B3 were obtained by adding 0.01 part by weight of hydrotalcite as a neutralizing agent and 0.15 part by weight of Irganox 1010 (commercial name, mfd. by Ciba Specialty Chemicals) as an antioxidant to 100 parts by weight of a powder of propylene-based polymer B3, and then melt kneading at 230° C. The pellets B3 had an intrinsic viscosity of 1.59 dl/g, a weight average molecular weight (Mw) of 2.63×10⁵, a molecular weight distribution (Mw/Mn) of 3.9, an MFR of 8.9 g/10 min, a die swell ratio (SR) of 1.22, a Tm of 162.8° C., a cold xylene soluble fraction content, CXS, of 1.1% and a flexural modulus of 1500 MPa.

### Example 1

96 Parts by weight of propylene-based polymer A1 and 4 parts by weight of propylene-based polymer B1 were mixed with a Henschel mixer and then pelletized at 220° C. using a 65 mm+extruder. The composition, melt flow rate, Tm and CXS of the resulting pellets are shown in Table 1. The pellets were subjected to film fabrication according to (12) described previously. The stretch processability of the pellets during their film fabrication is shown in Table 2. The physical properties of the film are shown in Table 2.

### Example 2

A film was obtained by the same method as that described in Example 1 except that propylene-based polymer B2 was used in place of the propylene-based polymer B1. The composition, melt flow rate, Tm and CXS of the mixture obtained through the kneading are shown in Table 1. The physical properties and stretch processability of the film are shown in Table 2.

### Example 3

A film was obtained by the same method as that described in Example 1 except that propylene-based polymer A2 was used in place of the propylene-based polymer A1. The composition of the mixture obtained through kneading is shown in Table 1 and the stretch processability thereof is shown in Table 2. The physical properties of the film are shown in Table 2.

### Example 4

A film was obtained by the same method as that described in Example 1 except that 80 parts by weight of propylene-based polymer A2 was used in place of the propylene-based polymer A1 and the amount of the propylene-based polymer B1 was increased to 20 parts by weight. The composition of the mixture obtained through kneading is shown in Table 1 and the stretch processability thereof is shown in Table 2. The physical properties of the film are shown in Table 2.

### Example 5

A film was obtained by the same method as that described in Example 1 except that propylene-based polymer A2 and propylene-based polymer B2 were used in place of the propylene-based polymer A1 and the propylene-based polymer B1, respectively. The composition of the mixture obtained through kneading is shown in Table 1 and the stretch processability thereof is shown in Table 2. The physical properties of the film are shown in Table 2.

### Comparative Example 1

A film was obtained by the same method as that described in Example 1 except that 100 parts by weight of propylene-based polymer A1 was used alone without using propylene-based polymer B1. The composition of the mixture obtained through kneading is shown in Table 1 and the stretch processability thereof is shown in Table 2. The physical properties of the film are shown in Table 2.

### Comparative Example 2

A film was obtained by the same method as that described in Example 1 except that 100 parts by weight of propylene-based polymer A2 was used alone in place of propylene-based polymer A1 and propylene-based polymer B1. The composition of the mixture obtained through kneading is shown in Table 1 and the stretch processability thereof is shown in Table 2. The physical properties of the film are shown in Table 2.

### Comparative Example 3

A film was obtained by the same method as that described in Example 1 except that 100 parts by weight of propylene-based polymer B1 was used alone without using propylene-based polymer A1. The composition of the mixture obtained through kneading is shown in Table 1 and the stretch processability thereof is shown in Table 2. The physical properties of the film are shown in Table 2.

### Comparative Example 4

A film was obtained by the same method as that described in Example 1 except that 96 parts by weight of propylene-based polymer A2 and 4 parts by weight of propylene-based polymer B3 were used in place of propylene-based polymer A1 and propylene-based polymer B1. The composition of the mixture obtained through kneading is shown in Table 1 and the stretch processability thereof is shown in Table 2. The physical properties of the film are shown in Table 2.

### Comparative Example 5

A film was obtained by the same method as that described in Example 1 except that 96 parts by weight of propylene-based polymer A3 and 4 parts by weight of propylene-based polymer B1 were used in place of propylene-based polymer A1 and propylene-based polymer B1. The composition of the mixture obtained through kneading is shown in Table 1 and the stretch processability thereof is shown in Table 2. The physical properties of the film are shown in Table 2.

### Comparative Example 6

A film was obtained by the same method as that described in Example 1 except that 96 parts by weight of propylene-based polymer A4 and 4 parts by weight of propylene-based polymer B1 were used in place of propylene-based polymer A1 and propylene-based polymer B1. The composition of the mixture obtained through kneading is shown in Table 1 and the stretch processability thereof is shown in Table 2. The physical properties of the film are shown in Table 2.

TABLE 1

Preparation of polypropylene
resin composition

| | | |
|---|---|---|
| Propylene-based | Propylene-based | Blend |

| | polymer | polymer | ratio | MFR | Tm | CXS |
|---|---|---|---|---|---|---|
| | (A) | (B) | A/B (wt %) | (g/10 min) | (° C.) | (wt %) |
| Example 1 | A-1 | B-1 | 96/4 | 6.2 | 139.1 | 2.2 |
| Example 2 | A-1 | B-2 | 96/4 | 5.8 | 141.8 | 2.3 |
| Example 3 | A-2 | B-i | 96/4 | 2.9 | 135.0 | 3.0 |
| Example 4 | A-2 | B-i | 80/20 | 3.4 | 149.5 | 2.3 |
| Example 5 | A-2 | B-2 | 96/4 | 3.1 | 138.7 | 3.6 |
| Comparative | A-1 | — | 100/0 | 5.8 | 136.0 | 2.3 |
| Example 1 | | | | | | |
| Comparative | A-2 | — | 100/0 | 3.1 | 130.7 | 3.1 |
| Example 2 | | | | | | |
| Comparative | — | B-1 | 0/100 | 12.0 | 165.2 | 0.4 |
| Example 3 | | | | | | |
| Comparative | A-2 | B-3 | 96/4 | 3.1 | 133.6 | 3.1 |
| Example 4 | | | | | | |
| Comparative | A-3 | B-1 | 96/4 | 5.7 | 142.3 | 2.1 |
| Example 5 | | | | | | |
| Comparative | A-4 | B-1 | 96/4 | 6.9 | 149.0 | 0.9 |
| Example 6 | | | | | | |

TABLE 2

| | Young's modulus | | Heat shrinkage | | Weld-cut seal | |
|---|---|---|---|---|---|---|
| | MD | TD | MD | TD | strength | Stretch |
| | (kg/cm²) | (kg/cm²) | (%) | (%) | (N) | processability |
| Example 1 | 13800 | 26400 | 9.6 | 14.8 | 6.0 | Good |
| Example 2 | 13600 | 25300 | 8.5 | 12.5 | 10.2 | Good |
| Example 3 | 10800 | 15700 | 11.1 | 19.0 | 4.4 | Good |
| Example 4 | 12900 | 22500 | 11.0 | 16.8 | 7.6 | Good |
| Example 5 | 10100 | 16000 | 9.6 | 15.1 | 5.3 | Good |
| Comparative | 13400 | 25800 | 9.6 | 15.4 | 3.3 | Good |
| Example 1 | | | | | | |
| Comparative | 10300 | 15400 | 10.9 | 18.4 | 3.7 | Good |
| Example 2 | | | | | | |
| Comparative | — | — | — | — | — | Cracking |
| Example 3 | | | | | | |
| Comparative | 10900 | 16000 | 11.5 | 17.2 | 3.4 | Good |
| Example 4 | | | | | | |
| Comparative | 13000 | 25800 | 9.5 | 15.7 | 4.2 | Unevenly |
| Example 5 | | | | | | stretched |
| Comparative | — | — | — | — | — | Cracking |
| Example 6 | | | | | | |

The films described in Examples 1 to 7, which satisfy the requirements of the present invention, are superior in Young's modulus, heat shrinkage, weld-cut seal strength and the compositions from which the films of Examples 1 to 7 were produced were superior in stretch processability. On the other hand, the films of Comparative Examples 1 and 2 containing no polymer (B), which is one of the requirements of the present invention, are insufficient in weld-cut sealability. The composition of Comparative Example 3 containing no polymer (A), which is one of the requirements of the present invention, is insufficient in stretchability. The film of Comparative Example 4 containing a polymer having a small SR in place of polymer (B), which is one of the requirements of the present invention, is insufficient in weld-cut sealability. The compositions of Comparative Examples 5 and 6 containing a polymer having a high melting point in place of polymer (A), which is one of the requirements of the present invention, are insufficient in stretchability.

As described in detail above, according to the present invention, a heat-shrinkable film superior in rigidity, heat shrinkage and weld-cut sealability, and a polypropylene resin composition which is superior in stretch processability and which is suitable as a raw material of such a heat-shrinkable film can be obtained.

What is claimed is:

1. A polypropylene resin composition comprising from 20 to 99.99 parts by weight of a propylene-based polymer (A) having a die swell ratio of less than 1.7 and a melting point defined as a peak temperature of a peak with a maximum intensity in a melting curve measured by DSC of from 125 to 139° C., and from 0.01 to 80 parts by weight of a propylene-based polymer (B) having a die swell ratio of not less than 1.8.

2. The polypropylene resin composition according to claim 1, wherein the propylene-based polymer (B) is a propylene polymer (C) obtained by a polymerization method comprising a step of producing a crystalline propylene polymer portion (a) having an intrinsic viscosity of not less than 5 dl/g and a step of producing a crystalline propylene polymer portion (b) having an intrinsic viscosity of less than 3 dl/g, wherein the content of the crystalline propylene polymer portion (a) relative to the propylene polymer (C) is from 0.05 to 35% by weight, wherein the propylene polymer (C) has an intrinsic viscosity of less than 3 dl/g and a molecular weight distribution of less than 10.

3. The polypropylene resin composition according to claim 1 or 2, wherein the propylene polymer (B) is a polypropylene (D) having a branching index of less than 1 and a degree of strain hardening of not less than 0.1.

4. A heat-shrinkable film obtained by stretching at least uniaxially the polypropylene resin composition according to claim 1.
